(19) United States
(12) Patent Application Publication
(10) Pub. No.: US 2012/0291257 A1
(43) Pub. Date: Nov. 22, 2012

(54) METHOD OF USING A FASCIA VALANCE SYSTEM AS SIGNAGE

(75) Inventor: TYRONE JOHN ANTHONY PEREIRA, San Diego, CA (US)

(73) Assignee: NUTMEG INDUSTRIES, INC., Lake Elsinore, CA (US)

(21) Appl. No.: 13/111,165

(22) Filed: May 19, 2011

(51) Int. Cl. B23P 11/00

(52) U.S. Cl. 29/428

(57) ABSTRACT

A method of using a fascia valance system as signage, wherein the aluminum fascia valance is designed to accommodate a fabric insert. The fabric insert may be printed upon with wording or an image, such as a company trademark, logo, or tagline, or an advertisement. The user of the fascia valance system may remove and replace the inserts to accommodate the user's signage needs.

### FIELD OF THE INVENTION

The present invention relates in general to a novel method of using a fascia valance system as signage.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a pictorial view of a fascia valance wherein a fabric insert is being inserted into place to allow the fascia valance to be used as signage.

### DETAILED DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of the embodiments of the invention.

A method of using a fascia valance system as signage according to certain embodiments of the invention may include at least one aluminum fascia valance, wherein the aluminum fascia valance is designed to accommodate a fabric insert, such as the Skyline™ cassette fascia valance that is commercially available from RollEase, Inc., 200 Harvard Avenue, Stamford, Conn. 06902.

In some embodiments, fabric inserts may be printed upon with wording or an image. In one embodiment, the fabric inserts are printed upon with a company trademark, logo, or tagline. In another embodiment, the fabric insert may be printed upon with an advertisement.

According to certain embodiments of the invention, the user of the fascia valance system may remove and replace the inserts to accommodate the user's signage needs.

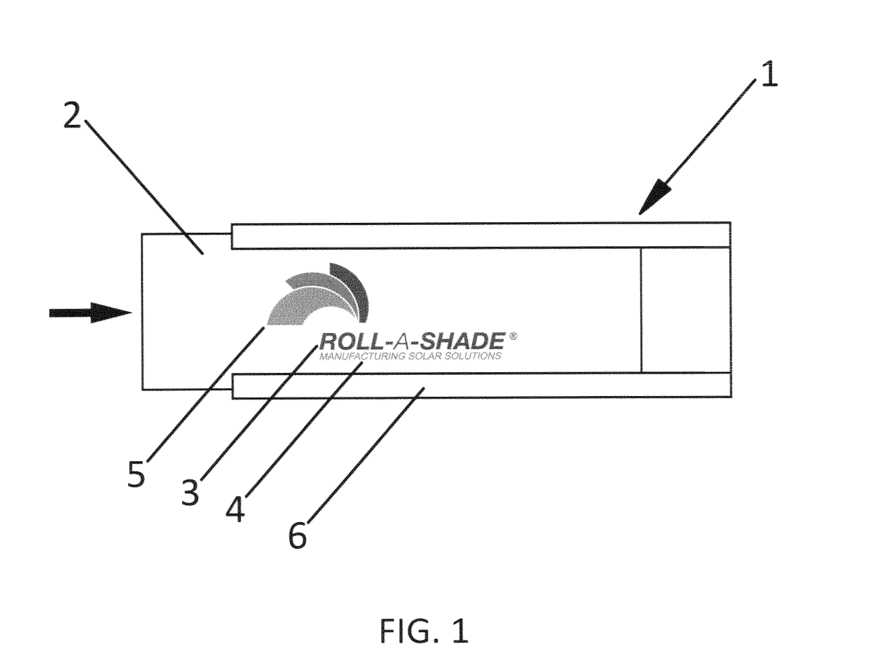

Referring now to the FIGURE, FIG. 1 shows an embodiment of the method of using a fascia valance system 1 as advertisement, wherein a fabric insert 2, which has been printed upon with wording, such as, but not limited to, a trademark 3 or a slogan 4, or an image, such as a logo 5, is being inserted into place in the fascia valance 6, to allow the fascia valance system 1 to be used as signage.

While particular embodiments of the present invention have been disclosed, it is to be understood that various different modifications are possible and are contemplated within the true spirit and scope of the appended claims. There is no intention, therefore, of limitations to the exact abstract or disclosure herein presented.

What is claimed is:

1. A method of using a fascia valance system as signage, wherein said method comprises:
providing an aluminum fascia valance, wherein said aluminum fascia valance is designed to accommodate a fabric insert;
providing a fabric insert, wherein said fabric insert has wording or an image printed upon its surface; and
inserting said fabric insert into said aluminum fascia valance so that the wording or image printed upon the fabric insert is visible.

2. The method of claim 1, wherein said method further comprises removing said fabric insert and replacing said fabric insert with another fabric insert, wherein the other fabric insert has different wording or a different image printed upon it.

3. The method of claims 1 and 2, wherein the wording is a company trademark or a tagline.

4. The method of claims 1 and 2, wherein the image is a company logo.

5. The method of claims 1 and 2, wherein the wording is an advertisement.
